(19) United States
(12) Patent Application Publication
(10) Pub. No.: US 2019/0023559 A1
(43) Pub. Date: Jan. 24, 2019

(54) HORSE HEADGEAR SYSTEM AND METHOD

(71) Applicant: Yonnick Firehorse, North Hollywood, CA (US)

(72) Inventor: Yonnick Firehorse, North Hollywood, CA (US)

(21) Appl. No.: 16/137,453

(22) Filed: Sep. 20, 2018

Related U.S. Application Data
(63) Continuation of application No. 14/961,474, filed on Dec. 7, 2015, now abandoned.

(51) Int. Cl. B68B 1/02; B68B 1/06; B68B 1/04

(52) U.S. Cl. CPC B68B 1/02; B68B 1/06; B68B 1/04

(57) ABSTRACT

The disclosure provides a headgear system for an animal (e.g., a horse) that may function as a halter and lead rope, hackamore, and bridal with various reining options and methods for making and using the same. The headgear may be converted between the various forms without its removal from the animal. The disclosure also provides connecters and adjustment fittings that may be used in the headgear system or in any system involving ropes or flaps that require length adjustment or attachment.

### CROSS-REFERENCE TO RELATED APPLICATIONS

This application is a continuation application of co-pending U.S. patent application Ser. No. 14/961,474, filed on Dec. 7, 2015. Priority to the prior application is expressly claimed, and the disclosure of the application is hereby incorporated herein by reference in its entirety.

### FIELD

The present application discloses headgear system and method for a horse or other riding animal that may function as a halter and lead rope, hackamore, and bridal with various reining options.

### BACKGROUND

Horses and other riding animals are usually controlled by means of various forms of headgear that apply pressure to the animal's head and/or mouth. There are various types of headgear in different configurations depending upon the position of the handler or rider and the type of control desired. Halters are the most basic headgear that allow a handler on the ground to control the animal while walking beside it or to tie the animal to fixed object (e.g., cross ties, etc.) Halters generally are affixed to the animals head but do not apply any specific or localized pressure to the animal's head or mouth. Bridles are used to control the animals when they are being ridden (e.g., under saddle). Bridles are characterized by a design that applies a specific or localized pressure to the animal's head and that pressure is communicated from the rider via the reins. Hackamores are bitless bridles that typically apply pressure to the bridge of the nose and/or under the chin when the reins are pulled by the rider. Bitted bridles are characterized by the presence of a mouth piece to which the reins are attached and that applies pressure within the animal's mouth and to the side of the cheeks. Combination bridals that are bitted hackamores are also known.

It is common for handlers to use a separate halter device and bridle device which requires the removal of one device in order to don the other device. This two-headgear system raises several problems. First, the animal has a moment of freedom when one device is being changed for the other. Animals that are flighty or not otherwise contained in a defined space may get loose and out of contact and control of its handler. Second, a handler necessarily has to carry the then-unused headgear if a change is later anticipated. For example, a rider controlling its animal with a bridle may have to carry a separate halter if a change of headgear is expected at the end of the ride.

The present disclosure addresses these problems by providing a single headgear system and method that does not have to be removed in order to switch between a halter-and-lead rope configuration and a bridle configuration. Furthermore, all system components may be used in both the halter and bridle configurations, eliminating the need for the handler to inconveniently carry extra headgear components.

### SUMMARY

In various aspects, the present disclosure sets forth a headgear system for a horse or other riding animal that may function as a halter and lead rope, hackamore, and bridal with various reining options.

In one aspect, the present disclosure sets forth a headgear system and method for an animal comprising

(a) a headstall;

(b) a noseband comprising
(i) a first reinstrap attached to the noseband on a first side with a first reinstrap end terminating in a first loop and extending to a second side, and
(ii) a second reinstrap attached to the noseband on a second side with a second reinstrap terminating in a second loop end extending to the first side,
wherein that the reinstrap ends form a cross and the cross is positioned below a jaw of the animal when the headgear system is worn; and

(c) a lead rope terminating in a reversible closure attached to the first loop and the second loop.

Optionally, the lead rope comprises a first rope reversibly attached to a second rope, wherein the first rope comprises a first eye, a first bite end, and a first terminal stopper sized to pass through the first eye; and wherein the second rope comprises a second eye, a second bite end, and a second terminal stopper sized to pass through the second eye. The first and second ropes may be separate or may be joined when the first terminal stopper is disposed through the first eye such that the first bite end forms a first loop, the second terminal stopper is disposed through the second eye such that the second bite end forms a second loop, and the first loop and second loop interlock.

In another aspect, the present disclosure sets forth a headgear system and method for an animal comprising

(a) a headstall comprising
(i) a first end terminating in a first loop and a first extension, the extension comprising a first terminal stopper that is sized to pass through the first loop, wherein when the first stopper is disposed through the first loop, the first extension forms a first closed loop, and
(ii) a second end terminating in a second loop and a second extension, the second extension comprising a second terminal stopper that is sized to pass through the second loop, wherein when the second stopper is disposed through the second loop, the second extension forms a second closed loop;

(b) a noseband; and

(c) a bit reversibly attached to the headstall comprising a first snaffle ring that that passes through the first closed loop and a second snaffle ring that passes through the second closed loop.

In another aspect, the present disclosure sets forth a slidable rope attachment junction comprising a first rope member, a second rope member terminating in a loop, a ring, and a slidable keeper joining the first rope member and the second rope member, wherein the ring is disposed around the second rope member and the first rope member runs through the loop but not through the ring. This attachment junction may be incorporated into any of the headgear systems set forth herein and is particularly useful for attaching a crown piece to a cheek piece. In particularly, the headstall may comprises a crown piece, a cheek piece terminating in a cheek piece loop, a ring, and a slidable keeper joining the cheek piece and the crown piece, wherein the ring is disposed around the cheek piece and the crown piece runs through the cheek piece loop but not through the ring. When an adjustment is desired, the crown piece (first rope member) slides through the loop in either the lengthening or shortening direction without the need to disassemble the attachment junction. The slidable keeper slides towards the loop to apply pressure between the ring and the crown piece (first rope member). The slidable keeper may be moved away from the loop to release pressure and enable adjustment with minimal force.

In another aspect, the present disclosure sets forth a rope or strap having a terminal end comprising an eye, a bite end, and a terminal stopper that is sized to pass through the eye, wherein the bite forms a loop when the terminal stopper is disposed through the eye. The eye may be defined and/or reinforced with a grommet. In one embodiment, the terminal stopper is smaller than the eye in a first dimension and larger than the first eye in a second dimension. In another embodiment, the terminal stopper is a monkey fist.

In another aspect, the present disclosure sets forth a method for changing between a halter and a bitted bridle using the headgear described herein. To change from a halter configuration to a bitted bridle configuration, the closed loops formed by the headstall extensions are opened, a bit is placed in the animal's mount and elevated to align the snaffle ring or other attachment point with the open loops, and the loops are then closed, securing the bit within the animal's mount to the headstall. The process is reversed to change from a bitted bridle configuration to a halter configuration.

By “riding animal” is meant any animal for a handler alternately desires control from the ground and while mounted. Riding animals include, for example, horses, camels, alpacas, llama, cows and bulls, sheep, and goats. Although reference to horses is made herein, such reference is not limiting on the species of animals to which the disclosed headgear may be adapted.

By “headstall” is meant the piece of the headgear system that is configured to pass over the animal's head behind the ears and is attached to at least one of (i) the noseband 120, (ii) a hackamore, and (iii) a bit one both sides of the animal's head. In one embodiment, the headstall 110 is fashioned as a single segment connected at each end to the noseband, hackamore, and/or bit (i.e., the headstall is a combination of the crown piece 112 and two cheek pieces 114). In another embodiment, the headstall 110 consists of a crownpiece 112 that is attached to the noseband, hackamore, and/or bit at one end on a first side of the animal's head and to a cheek piece 114 on the second side of the animal's head, wherein the cheek piece 114 attaches to the noseband, hackamore, and/or bit on that second side. In another embodiment, the headstall 110 consists of a crown piece 112 attached to two cheek pieces 114 (one on each side of the animal's head), wherein each cheek piece 114 is attached to the noseband, hackamore, and/or bit. Optionally, the headstall 110 is adjustable in one or more places to accommodate animals having differently-sized heads using one or more adjustors 150.

By “lead rope” is meant any rope or strap that may be reversibly attached to the head gear system and is configured to allow a handler on the ground to control the animal wearing the headgear. Lead ropes may be fashioned from a single element (e.g., a single rope/rein as described herein) or may be formed by joining multiple elements (e.g., two rope/reins joined at one end, as described herein). The lead rope may comprise a single type of material (e.g., a rope or a leather or nylon strap) or it may be constructed from different materials (e.g., a rope or a leather/nylon strap with a metal chain terminating in a reversible connector such as a snap).

By “reversible closure” is meant any device that is capable of being attached to and detached from the headgear system, preferably through an eye or loop provided on the headgear system. Reversible closures include, for example, buckles, snaps, and reversible loop closures as described in FIG. 9.

By “adjustor” is meant any mechanism that facilitates an adjustment to the size of any component of the headgear system 100. For example, adjusters are particularly useful on the headstall 110 in order to accommodate animals having varying head sizes. Adjustors may include any useful mechanism including buckles and sliding attachments as described herein.

These and other aspects of the present disclosure will now become apparent to those of ordinary skill in the art upon review of the following description of selected embodiments herein in conjunction with the accompanying drawings.

### BRIEF DESCRIPTION OF THE DRAWINGS

FIG. 1 illustrates the portion of the headgear system that is worn about the head of the animal and contains the Indian hackamore feature.

FIG. 2 illustrates the headgear system in a halter and lead rope configuration.

FIG. 3 illustrates the headgear system in a bitless bridle (hackamore) configuration.

FIG. 4 illustrates the headgear system in another bitless bridle (hackamore) configuration.

FIG. 5 illustrates the headgear system in another bitless bridle (hackamore) configuration.

FIG. 6 illustrates the headgear system in a bitted bridle configuration.

FIG. 7A is a magnification of a portion of the headgear system in a bitted bridle configuration with a reversible closure in the closed position.

FIG. 7B is a magnification of a portion of the headgear system in a bitted bridle configuration with a reversible closure in the open position.

FIG. 8A illustrates an attachment mechanism.

FIG. 8B illustrates an adjustable attachment mechanism.

FIG. 9A-9B illustrates a reversible attachment mechanism.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The present disclosure relates to a combination halter-bridle headgear system and various specialized connectors to allow the system to be converted among its various forms without being removed from the animal.

The Headgear System

The headgear system is based on an Indian hackamore design in which two reinstraps attached at or near the noseband on opposite sides of the animal's head cross underneath the jaw and are attached to a rein on the side opposite to its attachment. The crossed reinstraps, when pulled, tighten and exert pressure on the bottom of the jaw and/or bridge of the nose.

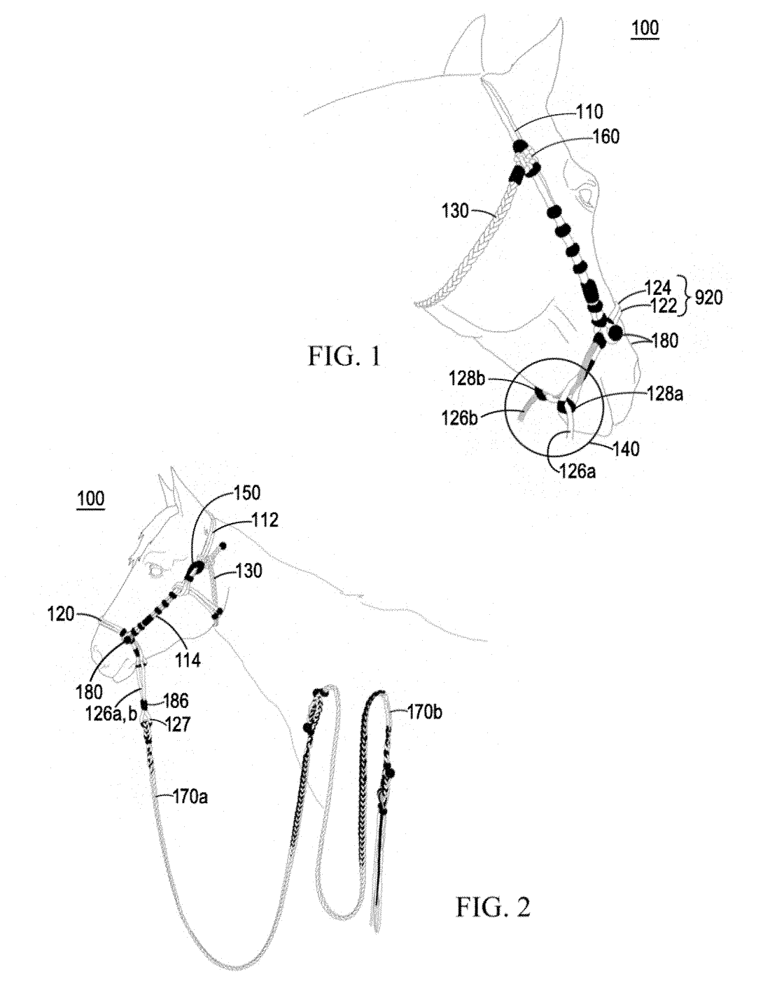

FIG. 1 illustrates the basic headgear and FIG. 2 illustrates the headgear in a halter-and-lead rope configuration. The headgear system 100 consists of a headstall 110 having a crown piece 112 and a cheek piece 114, and a noseband 120. Optionally, the headgear system also has a throat latch 130 which may be reversibly attached to the headstall 110 on one or both ends. Optionally, the headgear system also has a fixed or removable brow band (not shown).

The noseband 120 is configured as an Indian hackamore 140. In one embodiment, the hackamore 140 that has a noseband strap 122 that spans the bridge of the nose and terminates in a loop on each end 128a and 128b. The noseband 120 also has two reinstraps 126a and 126b. The first reinstrap 126a passes through the first loop 128a in the outside to inside direction and then through the second loop 128b in the inside to outside direction such that the first reinstrap 126a cross underneath the jaw. Likewise, the second reinstrap 126b passes through the second loop 128b in the outside to inside direction and then through the first loop 128a in the inside to outside direction such that the second reinstrap 126b cross underneath the jaw in the opposite direction of the first reinstrap 126a. The reinstraps 126a,b may be formed of a contiguous piece 124 that crosses the bridge of the nose, wherein the reinstraps represent the bites (terminals) of that piece, or the reinstraps may be discontinuous pieces affixed to the noseband strap 122. Optionally, the contiguous piece 124 is attached to the noseband strap 122 to form a single functional unit of the two fused elements. In one embodiment, the reinstraps 126 are configured to extend about 6-24 inches beyond the loops 128a,b. The reinstraps 126 terminate in one member of a fastening pair in order to facilitate attachment to the rope/reins 170. Optionally, the reinstraps 126 terminate in a reinstrap eye 127. In one embodiment, the reinstrap eye 127 is formed by looping the reinstrap member 126 back on itself and defining the eye 127 using a seizing 186. The headgear system 100 also has a bit loop 180 at each junction of the headstall and the noseband 120.

FIG. 2 illustrates the headgear system 100 in the halter-lead rope configuration including a first rope/rein 170a and a second rope/rein 170b. The first rope/rein 170 is attached on a first end to both reinstraps 126a and 126b. The second rope/rein 170b is optionally is attached on a second end of the first rope rein 170a to extend the length of the lead rope in this configuration, but may be absent. The first rope/rein 170a may be reversibly attached to the reinstraps 126a,b and/or the second rope/rein 170b using any suitable connector such as a buckle, snap, clasp, or loop connector as described herein. In use, this configuration acts as a halter. The attachment of both reinstraps 126a,b to a single rope/rein 170 allows the handler to control the animal from the ground using the customary single lead rope. The hackamore 140 feature provides an extra measure of control relative to a standard halter by allowing the handler to cause the application of specific pressure to the bridge of the animals' nose or bottom of the jaw.

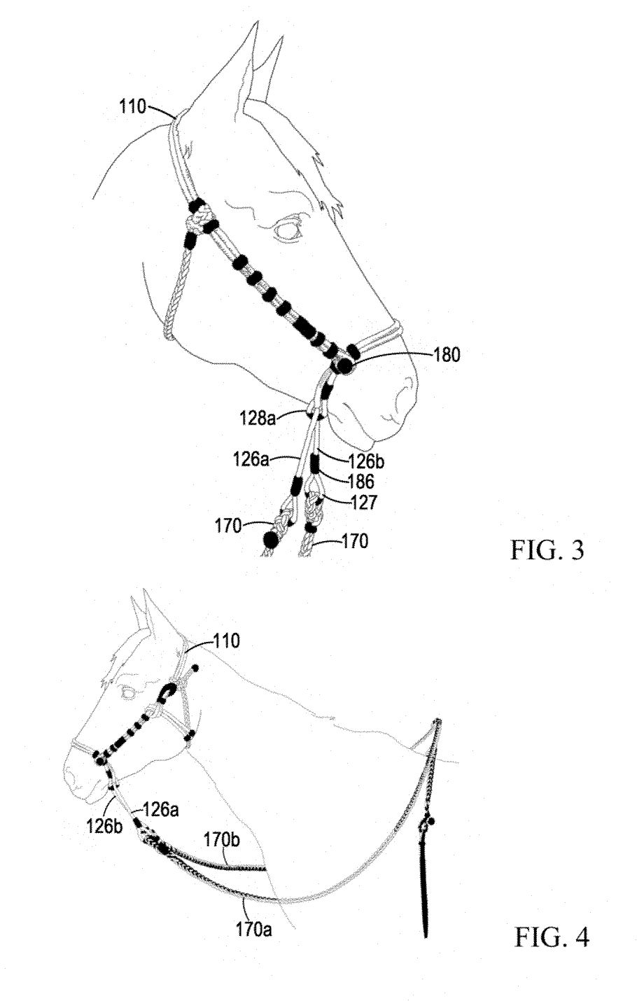

FIG. 3 illustrates the headgear system 100 in a hackamore bridle configuration. To convert the headgear system 100 from the halter configuration illustrated in FIGS. 1-2 into a hackamore bridle configuration, a single end of a rope/rein 170 is attached to each reinstrap 126.

FIG. 4 illustrates a headgear system that uses two rope/reins 170a,b, as illustrated in the hackamore configuration (FIG. 3), in which the first rope/rein 170a is attached to the first reinstrap 126a and the second rope/rein 170b is attached to the second reinstrap 126b. As is customary, the two rope/reins 170 are disposed on opposite sides of the animal's neck and under independent control by the mounted rider. FIG. 4 illustrates a two-rein system in with the two rope/reins 170a,b are not attached to each other.

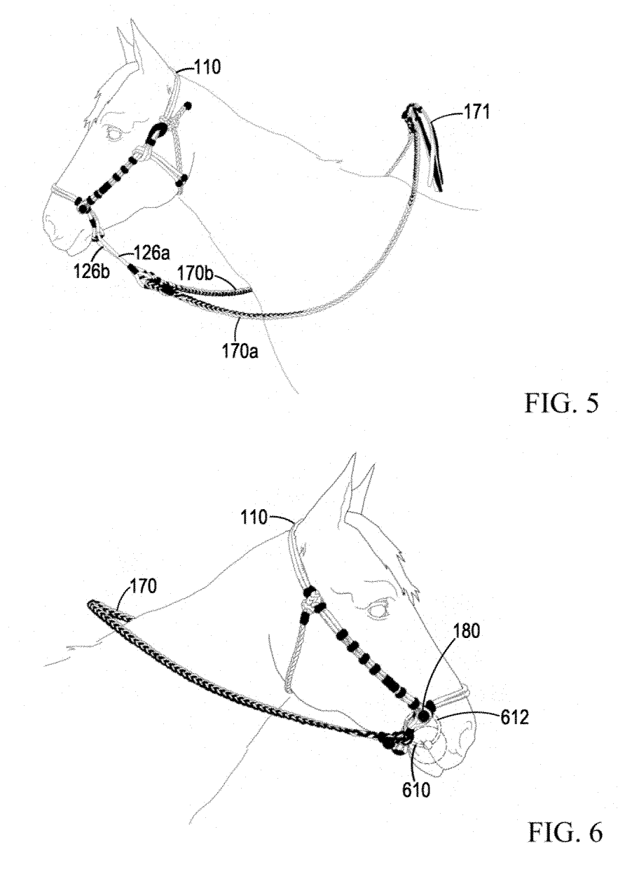

FIG. 5 illustrates a one-rein system in the hackamore configuration in which the two rope/reins 170a,b are attached to each other at their free ends by a suitable connector 171 (e.g., a buckle, snap, clasp, or loop connector as described herein). It is understood that the a one-rein system may be formed in which a single rope/rein 170a is attached at opposite ends to both reinstraps 126a,b, as illustrated in the bitted bridle configuration of FIG. 6.

FIG. 6 illustrates the headgear system 100 in a bitted bridle configuration. To convert the headgear system 100 from the halter configuration illustrated in FIGS. 1-2 into a bitted bridle configuration, the bit loops 180 are opened, the bit 610 is placed into the animal's mouth and elevated to align the snaffle rings 612 with the open bit loops 180, and the bit loops 180 are closed to secure the snaffle rings 612 to the headstall 110. The bit loops 180 may be any connector suitable for securing the snaffle rings 612 to the headstall 100 including, for example, a buckle, snap, clasp, or loop connector as described herein). One or more rope/reins 170 may be attached to the snaffle ring 612 to serve as reins in the standard manner. In one embodiment, two rope reins 170a,b may be attached individually to the snaffle ring 612 and either used in a single-rein or two-rein configuration as described above. FIG. 6 illustrates a single-rein configuration in which only a single rope-rein 170 is attached to the snaffle rings 612 at each of its two ends. The choice of a single-rein with a single rope/rein 170, a single-rein with two rope/reins 170a,b in which the two rope reins are attached to each other at their free ends, or a double rein in which the two rope reins 170a,b are not attached to each other is selected by the rider based on the preference of rein format and the desired rein length.

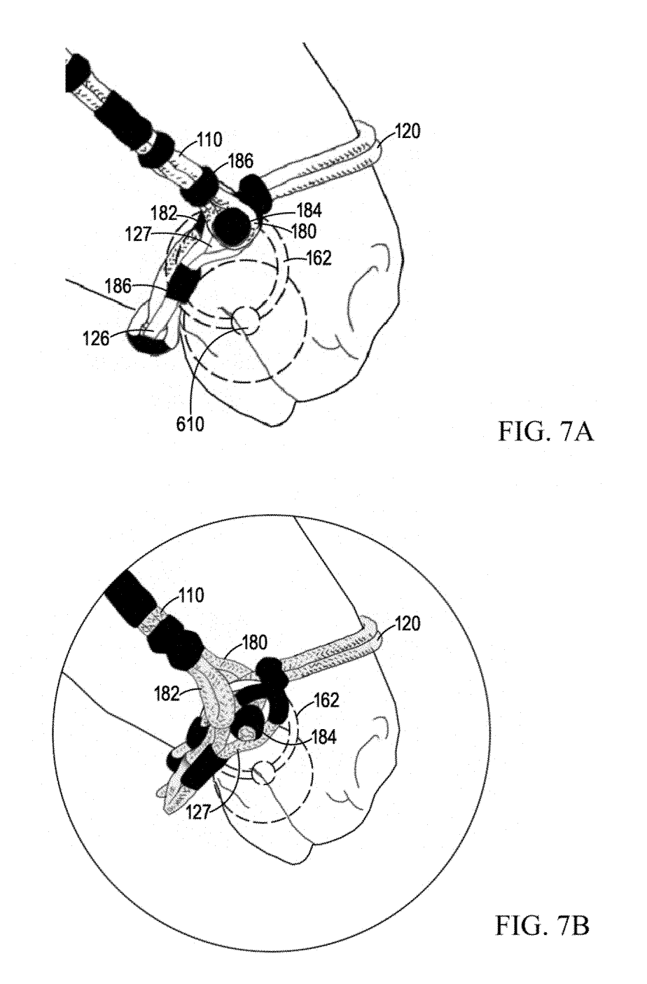

FIG. 7A illustrates one specific implementation of the headgear system 100 in a bitted bridle configuration. The bit loop is illustrated in the closed configuration and is formed as an eye-and-stopper system. The headstall 110 terminates in an eye 182 at the about the junction point with the noseband 120. Optionally, the eye 182 is formed by looping the headstall member 110 back on itself and defining the eye 182 using a seizing 186. The junction point of the headstall 110 and noseband 120 also contains a headstall extension 180 which is short rope member that terminates in a stopper 184. The headstall extension 180 may be attached the headstall 110 or attached to the noseband 120 if the noseband 120 is attached to the headstall. The stopper 184 is configured to pass through the eye 182 such that it forms a secure but reversible closure. Optionally, the stopper is a monkey fist or a disc. The headstall extension 180 is configured to form a loop to hold the bit 610 in place in the animal's mouth when the stopper is engaged through the eye 182. Specifically, the snaffle ring 612 is held in place in the closed space defined by the headstall extension 180 and the eye 182. The reinstraps 126 are not used in the bitted bridle configuration. As further illustrated in FIG. 7, the reinstrap eye 127 optionally is disposed within the bit loop formed by the headstall extension 180 and the eye 182.

FIG. 7B illustrates the bit loop containing a bit in the open configuration. As illustrated, the headstall extension 180, terminating in a stopper 184 is passed through the snaffle ring 162 and the reinstrap eye 127. Optionally, the headstall extension 180 also attaches the noseband 120 to the headstall 110. As illustrated in FIG. 7B, the stopper 184 is not secured through the eye 182 which allows the user to insert or remove the reinstrap eye 127 and/or the snaffle ring 162. Passing the stopper 184 through the eye 127 forms the closed configuration illustrated in FIG. 7A.

Fasteners And Construction Of The Headgear System

The headgear system 100 may be constructed of any suitable material including, for example, rope (nylon, polypropylene, hemp, fiber, cotton, etc.) and straps (e.g., leather, nylon, polypropylene, etc.). Suitable types of rope include monofiliament, cored, braided, and twisted ropes.

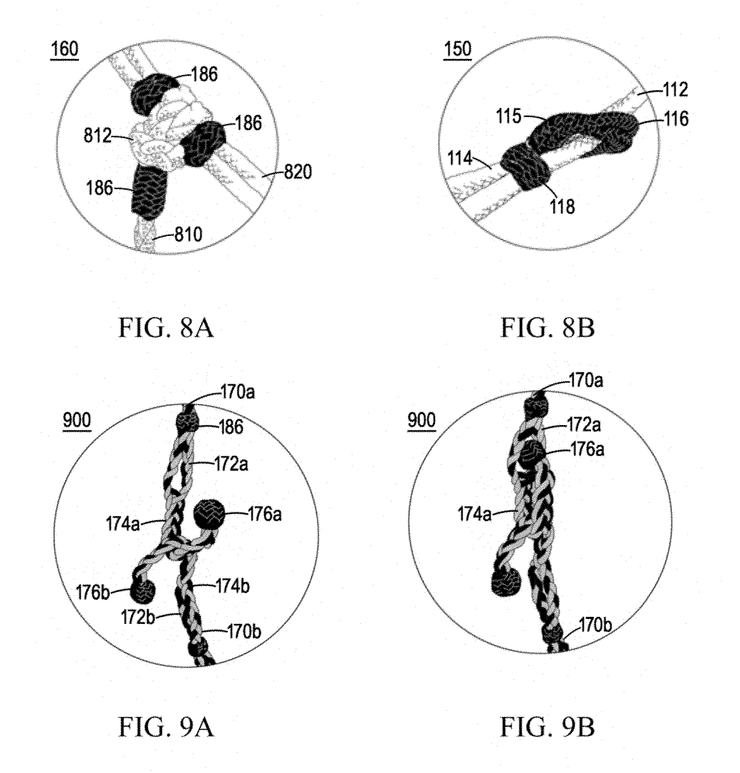

FIG. 8A illustrates one useful configuration for constructing the headgear system 100 by joining ropes without the need to cut, splice, or split the ropes to be joined. To create attachment 160, a loop 812 in formed at the end a first rope 810 and passed around a second rope 820. The bite of the first rope 810 is then passed through the loop of the first rope 810 and tightened to secure the first rope 810 in the desired location on the second rope 820. Optionally, the loop 812 may be secured using a seizing 186 on the first rope 810. Optionally, the position of the first rope is fixed by one or more seizings 186 on the second rope 820. This attachment method is particularly useful for joining a reversibly or irreversibly attached end of a throat latch 130 to a headstall 110.

FIG. 8B illustrates an adjustor 150 useful in the construction and fitting of the headgear system 100 when it is desired to join two independent rope members and provide a convenient slidable attachment for adjustment. The following description is exemplified in terms of the adjustor 150 between the crown piece 112 and the cheek piece 114 but it is understood that the adjustor 150 may be used at any junction of two elements that an adjustment to the size or length of any component of the headgear system 100 is desired. The adjustor 150 forms an adjustable junction between the cheek piece 114 and the crown piece 112. The cheek piece 114 ends with a loop 115. The loop 115 passes through the center of a ring 116. The crown piece 112 is passed through the loop 115 but not through the ring 116. Thus, the ring 116 is prevented from sliding off over the end of the loop 115 by the presence of the crown piece 112 being place through the loop 116. The crown piece 112 does not pass through the ring 116. The ring 116 applies pressure to the cheek piece 112 at the point where it passes through the loop 115. The crown piece 112 is joined to the cheek piece below the loop 115 and ring 116 using a slidable keeper 118. The slidable keeper is moved away from the junction (down) to relieve frictional pressure between the ring 116 and the crown piece to facilitate adjustment. Once the adjustment is complete by sliding the loop 115 relative to the crown piece 112, the keeper 118 is moved toward the junction to “lock” the loop-ring-crown piece junction into place.

FIG. 9 illustrates a reversible closure 900 that is useful in the headgear system 100. This reversible closure 900 is particularly useful for joining two rope/reins 170 together or joining a rope/rein 170 to a reinstrap eye 127 or snaffle ring 162. One or both ends of a rope/rein 170 has an eye 172, at bite end 174, and a terminal stopper 176. The eye 172 may be fashioned into a rope by splicing according to known method. Alternatively, a twisted rope may be unwound and a grommet inserted to define the eye 172. For straps, an eye 172 may be cut into the flat side of the strap and optionally reinforced with a grommet. The bite end 174 has a sufficient length to form a loop configured to accommodate the other pair member to which the rope/rein 170 is to be reversible attached. The bite end 174 terminates in a stopper 176. The stopper 176 is configured to pass through the eye 172 such that it forms a secure but reversible closure. In one embodiment, stopper 176 is larger than the eye 172 in at least one dimension (e.g., disc shaped). Optionally, the stopper is a monkey fist or a disc. FIG. 9A illustrates the open configuration of closure 900 for two rope/reins 170a,b. The bite ends 174a,b are crossed over each other and the first stopper 176a is passed through the first eye 172a. The second stopper 176b is passed through the second eye 172b in order to form interlocking loops thereby reversible attaching the two rope/reins 170. FIG. 9B illustrates the first step in which the first stopper 176a is passed through the first eye 172a.

The disclosed embodiments are susceptible to various modifications and alternative forms, and specific examples thereof have been shown by way of example in the drawings and herein described in detail. It should be understood, however, that the disclosed embodiments are not meant to be limited to the particular forms or methods disclosed, but to the contrary, the disclosed embodiments are to cover all modifications, equivalents, and alternatives.

What is calimed is:

1. A rope or strap having a terminal end comprising an eye, a bite end, and a terminal stopper that is sized to pass through the eye, wherein the bite forms a loop when the terminal stopper is disposed through the eye.

2. The rope or strap of claim 1, wherein the eye further comprises a grommet.

3. The rope or strap of claim 1, wherein the terminal stopper is smaller than the eye in a first dimension and larger than the first eye in a second dimension.

4. The rope or strap of claim 1, wherein the terminal stopper is a monkey fist.

5. A method for manufacturing a rope or strap having a terminal end, comprising:
disposing a terminal stopper through an eye of the rope or strap; and
forming a loop via a bite end of the rope or strap.

6. The method of claim 5, further comprising sizing the terminal stopper to pass through the eye of the rope or strap.

7. The method of claim 5, wherein the eye further comprises a grommet.

8. The method of claim 5, wherein the terminal stopper is smaller than the eye in a first dimension and larger than the first eye in a second dimension.

9. The method of claim 5, wherein the terminal stopper is a monkey fist.
